(19) United States
(12) Patent Application Publication
(10) Pub. No.: US 2016/0080478 A1
(43) Pub. Date: Mar. 17, 2016

(54) MANAGING OPERATIONS IN A CLOUD MANAGEMENT SYSTEM

(71) Applicant: International Business Machines Corporation, Armonk, NY (US)

(72) Inventors: Ramamohan Chennamsetty, Hopewell Junction, NY (US); Sreekanth R. Iyer, Bangalore (IN); Pradeep Kumar Kalale Srinivasa Prasad, Bangalore (IN); Archana Kumar, Bangalore (IN)

(21) Appl. No.: 14/928,017

(22) Filed: Oct. 30, 2015

Related U.S. Application Data
(63) Continuation of application No. 14/483,202, filed on Sep. 11, 2014.

(51) Int. Cl. H04L 29/08

(52) U.S. Cl. CPC H04L 67/10

(57) ABSTRACT

Embodiments of the present invention provide methods, systems, and computer program products for managing operations in a cloud management system. In one embodiment, after a user submits a request to perform a cloud operation, a contextual security assessment of the requesting user and/or cloud resources on which the requested operation will be performed can be determined. An administrative user can review the contextual security assessments before approving or rejecting the cloud operation, which can help increase safety within the cloud computing environment.

### BACKGROUND OF THE INVENTION

The present invention relates to a cloud management system, and more particularly to managing operations in cloud management systems.

A cloud administrator generally receives a large number of requests pertaining to performing cloud management operations of cloud resources that are virtualized and spread across multiple locations, as well as shared by multiple projects and tenants along with multiple tools. It can be very difficult for a cloud administrator to decide whether it is safe or unsafe to approve or deny such requests of cloud management operations without relevant context specific security information.

### SUMMARY

According to one aspect of the present invention, there is provided a method for managing operations in a cloud management system, the method comprising: receiving, by one or more computer processors, a user request for performing a cloud operation on a cloud resource in a cloud management system; determining, by one or more computer processors, a security assessment of the cloud operation based, at least in part, on an analysis of user data associated with the user request and cloud resource data associated with the cloud resource, wherein the user data and the cloud resource data are retrieved from one or more sources linked to the cloud management system; and displaying, by one or more computer processors, the security assessment in a display of the cloud management system.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node, in accordance with an embodiment of the present invention;

FIG. 2 depicts a cloud computing environment, in accordance with an embodiment of the present invention;

FIG. 3 depicts abstraction model layers, in accordance with an embodiment of the present invention;

FIG. 4 depicts an illustrative computing environment, in accordance with an embodiment of the present invention; and

FIG. 5 is a flowchart illustrating operation steps for managing cloud operations, in accordance with an embodiment of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

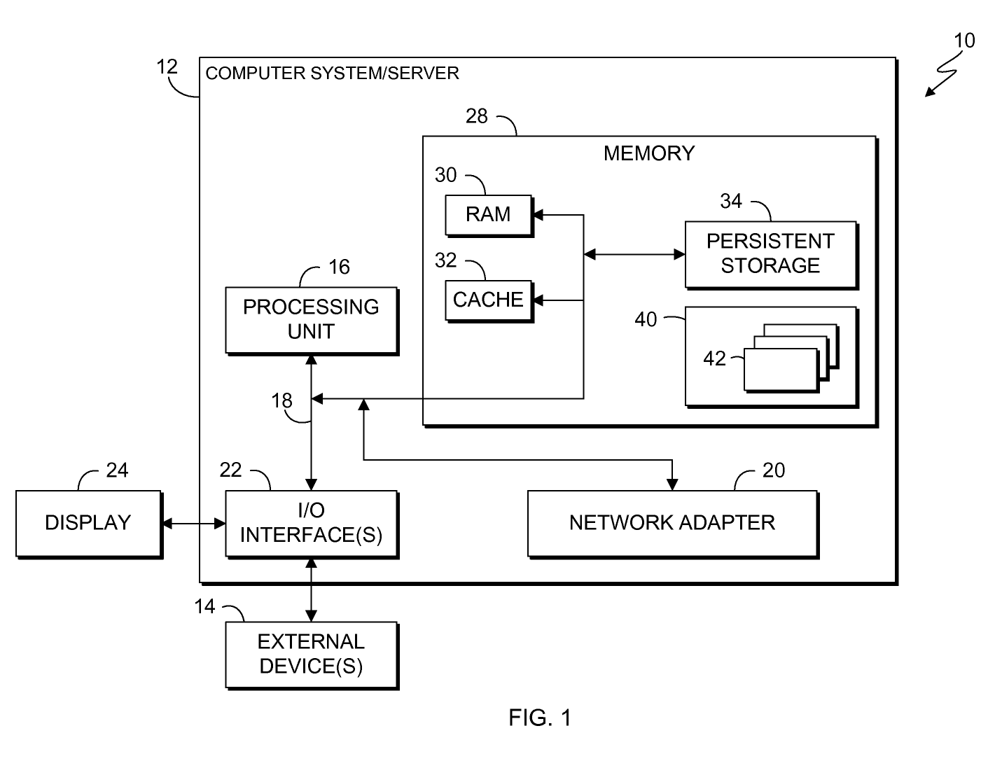

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

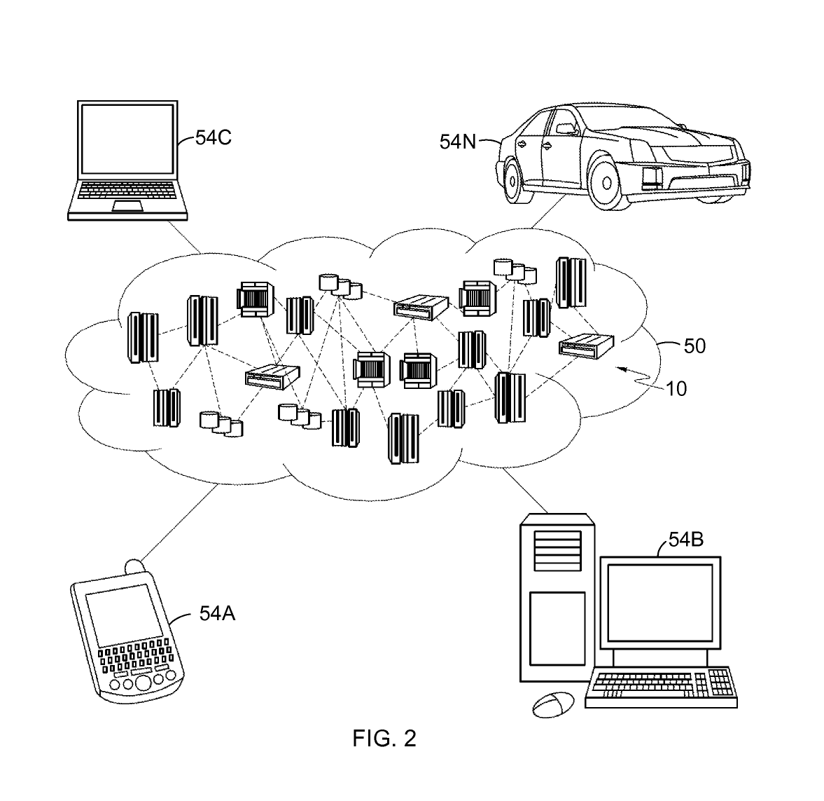

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

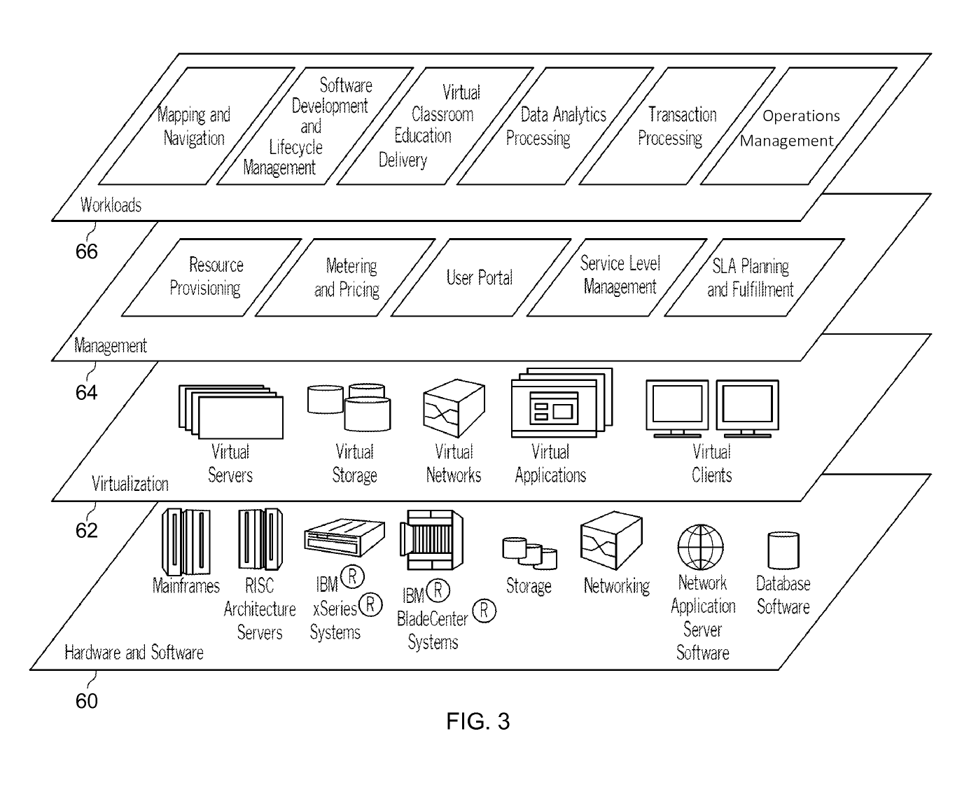

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network client, in one example IBM WebSphere® client; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA. Further shown in the management layer 64 is connection allocation, which represents the functionality that is provided under the embodiments of the present invention.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and cloud operations management.

It is reiterated that although this disclosure includes a detailed description on cloud computing, implementation of the teachings recited herein are not limited to a cloud computing environment. Rather, the embodiments of the present invention are intended to be implemented with any type of networked computing environment known now or later developed.

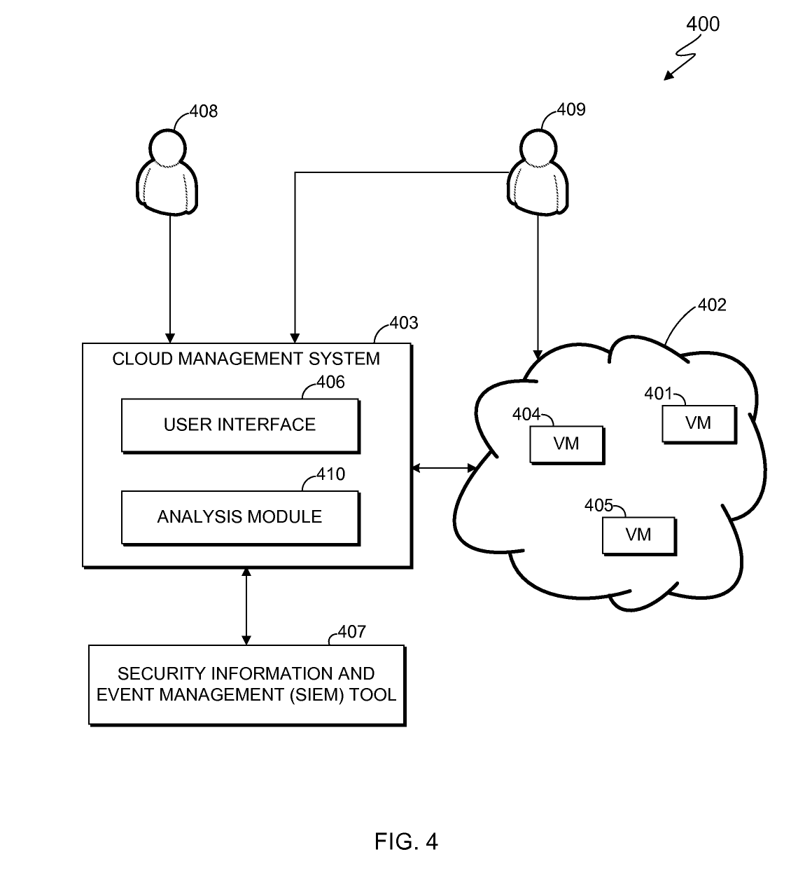

FIG. 4 depicts an illustrative environment 400, in accordance with an embodiment of the present invention. Environment 400 includes cloud computing environment 402, cloud management system 403, security information and event management (SIEM) tool 407, administrative user 408, and end user 409. In this embodiment, resources such as virtual machines (VM) 401, 404, and 405 are provisioned within one or more computing devices in cloud computing environment 402. Operations of cloud resources in cloud computing environment 402 are managed by cloud management system 403, which is operably connected to computing devices in cloud computing environment 402. Virtual machines 401, 404, and 405 can each include software implementations or virtualizations of a physical machine (i.e., computing device) executing particular operating systems (i.e. guest operating systems) and applications as if it was a real, physical computer. Virtual machines 401, 404, and 405 can each be isolated software containers, operating independently of other virtual machines. Such isolation can assist in realizing virtual-machine-based virtual environments that can execute applications and provide services with availability, flexibility, and security, in some cases, surpassing those on traditional, non-virtualized systems. Virtual machines 401, 404, and 405 can each encapsulate a complete set of virtual hardware resources, including an operating system and all its applications, inside a software package. Encapsulation can make virtual machines quite portable and manageable. Virtual machines 401, 404, and 405 can also be hardware-independent, and can be portably provisioned and deployed on one of multiple different computing devices, operating systems, and environments.

Cloud management system 403 can be implemented as software- and/or hardware-based tools used in the virtualization of hardware assets (i.e., virtual machines) on one or more host computing devices in cloud computing environment 402. Cloud management system 403 can be used to run and manage multiple virtual machines (e.g., virtual machines 401, 404, and 405), including virtual machines with different guest operating systems, on one or more computing devices. Cloud management system 403 can enable a plurality of different virtual machines (and guest operating systems) to be instantiated and run on computing devices and hardware hosting virtual infrastructure. Further, cloud management system 403 is configured to perform various cloud operations on virtual machines 401, 404, and 405, such as create, delete, clone and/or move virtual machines within cloud computing environment 402 and/or a different cloud computing environment managed by cloud management system 403.

In this embodiment, cloud management system 403 includes user interface 406 displayed on hardware of cloud management system 403, which allows administrative user 408 of cloud management system 403 to view and perform the aforementioned operations. End user 409 of virtual machines 401, 404, and 405 may request one or more of the aforementioned operations to be performed on one or more of virtual machines 401, 404, and 405 through cloud management system 403. Typically, rights to perform such operations are not granted to end users and can only be performed by administrative user 408 of cloud management system 403.

SIEM tool 407 is provided for managing security related aspects of cloud management system 403. SIEM tool 407 is communicatively interfaced with cloud management system 403. SIEM tool 407 may comprise an independent entity having separate physical and software architecture interfaced with cloud management system 403, and/or a software-based tool residing and executing natively on physical infrastructure of cloud management system 403. SIEM tool 407 is used to collect security-related data from cloud resources of cloud computing environment 402, such as data from event logs describing detected activities in the cloud resources that may have security implications, and to assist security-focused personnel in carrying out security procedures. Security procedures may include, for example, real-time monitoring of cloud resources to detect security vulnerabilities, obtaining data from other systems operatively connected to cloud resources, etc. SIEM tool 407 can include a database (not shown) in which the security-related data is stored. According to one embodiment of the present invention, security related data may include log information of historical activities of end user 409 (and other users) of cloud resources in cloud computing environment 402, past and current privilege information of end user 409 for cloud resources in cloud computing environment 402, and past and current health information of cloud resources in cloud computing environment 402. According to another embodiment, one or more other tools may also be provided.

In this embodiment, cloud management system 403 also includes analysis module 410. Analysis module 410 provides contextual analysis of security related data from STEM tool 407. Results from analysis module 410 may be integrated within user interface 406 of cloud management system 403 (e.g., for display to administrative user 408). According to an embodiment of the invention, whenever cloud management system 403 receives a request from end user 409 to perform a cloud operation (e.g., cloning VM 401 in cloud computing environment 402), analysis module 410 may retrieve at least two different types of data from SIEM tool 407 to determine a security assessment of the cloud operation: user data and cloud resource data.

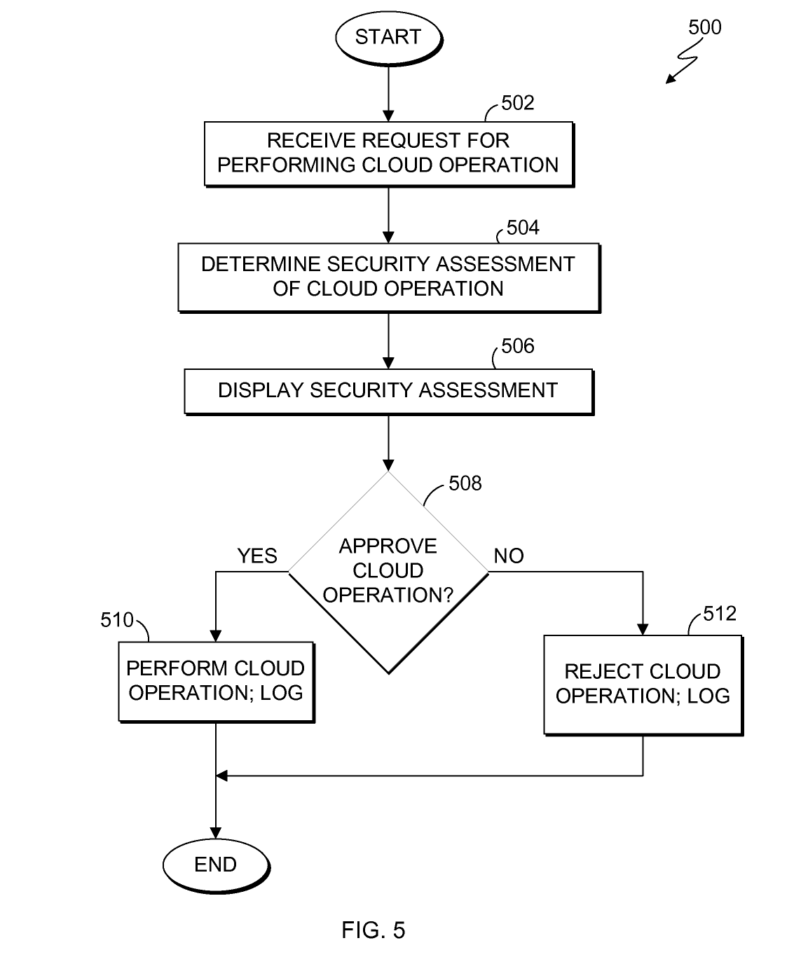

In this embodiment, user data comprises data associated with end user 409 (or other user(s)) who requested the cloud operation. For example, user data may include past and current privileges of end user 409 in cloud computing environment 402, past and current log information of various activities performed by end user 409, and location information of end user 409. Cloud resource data comprises data associated with the cloud resource (e.g., VM 401) on which the requested cloud operation is to be performed. For example, cloud resource data may indicate that the cloud resources is flagged because it is infected with malware. The aforementioned user data and cloud resource data may be obtained from SIEM tool 407 or similar such tools interfaced with cloud management system 403. Using this information, analysis module 410 may determine a contextual security assessment of end user 409 requesting the cloud operation and/or cloud resources on which the requested cloud operation is to be performed, which administrative user 408 can review before approving or rejecting the cloud operation, as discussed in greater detail with regard to FIG. 5. Accordingly, embodiments of the present invention can make cloud operations safer by providing administrative user 408 with more information about the safety of the cloud operation and user before approving or rejecting performance of those cloud operations.

FIG. 5 is a flowchart 500 illustrating operational steps for managing cloud operations, in accordance with an embodiment of the present invention. The operational steps of FIG. 5 may be performed, for example, each time end user 409 (or another user) requests that a cloud operation be performed in cloud computing environment 402.

At step 502, analysis module 410, operating on cloud management system 403, receives a user request for performing a cloud operation on a cloud resource in cloud computing environment 402. For example, end user 409 may create a request to clone VM 401 in cloud computing environment 402.

At step 504, analysis module 410 determines a security assessment of the requested cloud operation. In this embodiment, analysis module 410 determines the security assessment based on an analysis of user data associated with the user request (e.g., end user 409) and cloud resource data associated with the cloud resource (e.g., VM 401), both of which are received from SIEM tool 407. As previously discussed, user data may include past and current privileges of the user making the request, past and current log information of various activities performed by the user, and location information of the user. For example, analysis module 410 may retrieve from SIEM tool 407 user data that indicates that end user 409 has created the request by accessing VM 401 from a location that is different than the location from which end user 409 typically accesses VM 401. In another example, the retrieved user data may indicate that although end user 409 possessed necessary privileges at the time of creating the request, those privileges have since been revoked (e.g., end user 409 has left the organization). These and other such user data may be assessed as suspicious by analysis module 410.

In another example, analysis module 410 may retrieve from SIEM tool 407 cloud resource data that indicates that VM 401, on which the requested clone operation is to be performed, is infected with malware and is currently red-flagged by a security administrator of SIEM tool 407. Thus, based on these and other cloud resource data, VM 401 may be assessed by analysis module 410 as being suspicious from a security assessment point of view.

According to another embodiment of the present invention, analysis module 410 may analyze user data and/or cloud resource data based on one or more rules. For example, user data and/or cloud resource data retrieved from the SIEM tool 407 may be searched in a pre-determined matrix of user data and cloud resource data and corresponding security assessments. If there is a match, the security assessment from the matrix may be selected as the security assessment for the user data and/or cloud resource data retrieved from the SIEM tool 407. It will be appreciated that the contextual security analysis can be performed in many different ways and, as such, the above discussion is not to be construed as limiting embodiments of the present invention to the aforementioned described examples.

At step 506, analysis module 410 displays the determined security assessment via user interface 406 and a display device (e.g., monitor) of cloud management system 403. According to one embodiment of the present invention, the security assessments of the user (e.g., end user 409) and the cloud resource (e.g., VM 401) are independently highlighted against the cloud operation request displayed in user interface 406. According to another embodiment of the present invention, the security assessment of the user data and cloud resource data may be combined to come up with a final security assessment to be displayed or otherwise communicated in cloud management system 403. According to another embodiment, the security assessment displayed in cloud management system 403 includes detailed information about the security assessment to enable the administrator of cloud management system 403 to understand the security assessment and take appropriate action. Thus, in each of these embodiments, the administrator of cloud management system 403 (e.g., administrative user 408) will have first-hand information and a security assessment of the user who requested the cloud operation (e.g., end user 409) and the cloud resource on which the cloud operation will be performed (e.g., VM 401), before approving or rejecting the cloud operation, which can improve the safety of the cloud operation.

At step 508, analysis module 410 determines whether the cloud operation is approved. As previously discussed, the administrator of cloud management system 403 (e.g., administrative user 408) can, after reviewing the security assessment of the user data and/or cloud resource data, decide whether to approve or reject the requested cloud operation. Further, according to another embodiment, analysis module 410 may be configured to take an automatic action on (i.e., approve or reject) the requested cloud operation based on the security assessment of the user data and/or cloud resource data. Such automatic action may be based on pre-defined rules. For example, if the security assessment is found to be not suspicious, analysis module 410 may automatically grant an approval of the requested cloud operation. In another example, where the security assessment is not suspicious, but the cloud operation request itself is unusual and infrequent, automatic approval may be bypassed and the cloud operation request may be presented to the administrator of cloud management system 403 for approval, as described above. All of these and other such functions may be performed by analysis module 410 or a different module provisioned to review and perform the cloud operations automatically in cloud management system 403.

If, at step 508, analysis module 410 determines that the cloud operation is approved (e.g., administrative user 408 approves the cloud operation, pre-defined rules indicate that analysis module 410 should automatically approve the cloud operation, etc.), then, at step 510, analysis module 410 approves performance of the cloud operation, which allows the requested cloud operation to be performed (e.g., cloning of VM 401 in cloud computing environment 402). Analysis module 410 can also log details pertaining to the requested cloud operation, the security assessment, reasons why the cloud operation was approved, and other related information.

If, at step 508, analysis module 410 determines that the cloud operation is not approved (e.g., administrative user 408 denied the cloud operation, pre-defined rules indicate that analysis module 410 should automatically deny the cloud operation, etc.), then, at step 512, analysis module 410 rejects performance of the cloud operation, which prevents the requested cloud operation from being performed. Again, analysis module 410 can log details pertaining to the requested cloud operation, the security assessment, reasons why the cloud operation was rejected, and other related information.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing operations in a cloud management system, the method comprising:
receiving, by one or more computer processors, a user request for performing a cloud operation on a cloud resource in a cloud management system;
determining, by one or more computer processors, a security assessment of the cloud operation based, at least in part, on an analysis of user data associated with the user request and cloud resource data associated with the cloud resource, wherein the user data and the cloud resource data are retrieved from one or more sources linked to the cloud management system; and
displaying, by one or more computer processors, the security assessment in a display of the cloud management system.

2. The method of claim 1, further comprising:
automatically approving or rejecting, by one or more computer processors, the user request based on the determined security assessment.

3. The method of claim 2, wherein displaying, by one or more computer processors, the security assessment in a display of the cloud management system comprises displaying automatic approval or rejection information along with the security assessment.

4. The method of claim 1, wherein the cloud resource comprises a virtual machine (VM) and the cloud operation comprises at least one of the following operations: creating, deleting, cloning or moving the VM.

5. The method of claim 1, wherein the one or more sources linked to the cloud management system include a security information and event management (SIEM) tool comprising at least one of the following: log information of historical activities of the user, past and current privilege information of the user, and a past and current health information of the cloud resource.

6. The method of claim 1, wherein the analysis of user data and cloud resource data includes identification of one or more red flags therein based, at least in part, on pre-defined rules, and performing a contextual analysis to determine the security assessment.
